(19) United States
(12) Patent Application Publication
(10) Pub. No.: US 2024/0174504 A1
(43) Pub. Date: May 30, 2024

(54) GALLEY INSERT BEVERAGE MAKER

(71) Applicant: B/E Aerospace, Inc., Winston Salem, NC (US)

(72) Inventors: John Ervin Epan Albina, Santo Tomas (PH); Louie Manarang Perez, Tanauan (PH); Jordan Sherman Harn Dondoy, Binan (PH); Ariel A. Amoncio, Binan (PH)

(73) Assignee: B/E Aerospace, Inc., Winston Salem, NC (US)

(21) Appl. No.: 18/480,063

(22) Filed: Oct. 3, 2023

(30) Foreign Application Priority Data
Nov. 28, 2022 (EP) 22210036.4

(51) Int. Cl. B67D 3/00; B01F 27/1143; B01F 27/17; B01F 35/32; B01F 35/33; B01F 35/92; B64D 11/04

(52) U.S. Cl. CPC B67D 3/0012; B01F 27/1143; B01F 27/17; B01F 35/3204; B01F 35/331; B01F 35/92; B64D 11/04; B67D 3/0051; B67D 3/0087; B01F 2101/14

(57) ABSTRACT

A galley insert beverage making system for producing chilled drinks comprising: a body configured to be inserted into a vehicle galley compartment. The body comprises: a cooling system; and a motor. The galley insert beverage making system also comprises a pitcher system. The pitcher system comprises: a pitcher; a blending element configured to be rotationally driven by the motor; and a stirring element configured to be rotationally driven by the motor. The body defines a cavity configured to receive the pitcher, and the system is configured such that the cooling system cools the pitcher.

### CROSS-REFERENCE TO RELATED APPLICATIONS

This application claims priority to, and the benefit of, EP Patent Application No. 22210036.4, filed Nov. 28, 2022 and titled “GALLEY INSERT BEVERAGE MAKER,” which is incorporated by reference herein in its entirety for all purposes.

### FIELD

This disclosure relates to a beverage maker for making chilled drinks, such as frozen slush drinks. More particularly, the disclosure relates to a galley insert beverage maker for making chilled drinks, such as frozen slush drinks.

### BACKGROUND

Hot water dispensers are used in vehicle galleys (for the provision of hot drinks such as tea and coffee) and cold beverages (such as beer, cider, and soft drinks) are served on aircraft using cans and bottles, usually served with a cup containing ice. Therefore, the beverage options available on aircraft are limited, and with customers becoming more demanding, there is a need for the provision of alternative beverages on vehicles such as aircraft.

### SUMMARY

According to this disclosure, there is provided a galley insert beverage making system for producing chilled drinks comprising:
a body configured to be inserted into a vehicle galley compartment, the body comprising: a cooling system; and
a motor, and
a pitcher system comprising:
   a pitcher;
   a blending element configured to be rotationally driven by the motor; and
   a stirring element configured to be rotationally driven by the motor,
      wherein the body defines a cavity configured to receive the pitcher, and wherein the system is configured such that the cooling system cools the pitcher.

In embodiments, the blending element comprises a main shaft, and one or more blending blades protruding from the shaft.

In embodiments, the stirring element comprises a main shaft, and one or more stirring blades protruding from the shaft.

In embodiments, the body comprises a first meshing element (e.g. protruding from the floor of the cavity), which is coupled (e.g. fixedly coupled) to the motor, and the pitcher comprises a second meshing element (e.g. on its base), which is coupled (e.g. fixedly coupled) to the blending element and/or to the stirring element, wherein the first and second meshing elements are configured to be mated (e.g. rotationally fixed with respect to one another) when the pitcher is received inside (e.g. correctly placed in) the cavity such that rotational drive is transferred (directly or indirectly) from the motor to the blending element and/or to the stirring element.

In embodiments, the blending element is configured to be removable from the pitcher.

In embodiments, the stirring element is configured to be removable from the pitcher.

In embodiments, the stirring element comprises a stirring blade having a spiral shape.

In embodiments, the stirring element is formed as an Archimedes screw.

In embodiments, the stirring element is configured to removably attach to the blending element (e.g. to the top of the blending element).

In embodiments, the blending element comprises a third meshing element (e.g. at the top of the blending element) and the stirring element comprises a fourth meshing element (e.g. at the base of the meshing element), wherein the third and fourth meshing elements are configured to be mated (e.g. rotationally fixed with respect to one another) when the stirring element is attached to the top of the blending element such that rotational drive is transferred from the blending element to the stirring element (e.g. from the motor to the stirring element via the first meshing element, second meshing element, third meshing element, and fourth meshing element).

In embodiments, the pitcher comprises a drive shaft at the base of the pitcher, coupled to the meshing element, wherein the drive shaft comprises a fifth meshing element (e.g. at the top of the drive shaft), such that the drive shaft extends between the second meshing element and the fifth meshing element, wherein the fourth and the fifth meshing elements are configured to be mated (e.g. rotationally fixed with respect to one another) when the stirring element is attached to the drive shaft such that rotational drive is transferred from the drive shaft to the stirring element (e.g. from the motor to the stirring element via the first meshing element, second meshing element, drive shaft, fifth meshing element, and fourth meshing element). In such embodiments, the stirring element may be attached to the drive shaft in place of the blending element (e.g. the blending element and stirring element are interchangeable).

In embodiments, the blending element comprises a sixth meshing element (e.g. at the base of the blending element) wherein the fifth and the sixth meshing elements are configured to be mated (e.g. rotationally fixed with respect to one another) when the blending element is attached to the drive shaft such that rotational drive is transferred from the drive shaft to the blending element (e.g. from the motor to the blending element via the first meshing element, second meshing element, drive shaft, fifth meshing element, and sixth meshing element).

In embodiments, a plurality of the meshing elements are configured to be compatible, as such, it will be understood that the above described embodiments are not mutually exclusive and a meshing element may be configured to be mated with a plurality of other meshing elements.

In embodiments, the motor is configured to operate at (e.g. the system is configured to operate the motor at) at least two rotational speeds, a blending speed, and a stirring speed, wherein the blending speed is greater than the stirring speed.

In embodiments, the blending speed is greater than 5000 rpm (e.g. greater than 6000 rpm, greater than 7000 rpm). In embodiments the stirring speed is below 500 rpm (e.g. below 400 rpm, below 300 rpm, below 200 rpm).

In embodiments, the blending speed is 7000 rpm and the stirring speed is 100 rpm.

In alternative embodiments, the motor may comprise a gearbox, and the different speeds may be achieved by changing gear, whilst the motor itself operates at a constant rotational speed.

In embodiments, the cooling system comprises a cooling element located proximal to (e.g. at or close to the location of) the pitcher. In embodiments, the cooling element is in thermal communication with the pitcher.

In embodiments, the cooling element is configured to be in contact with (e.g. touching) an outer surface of the pitcher when the pitcher is received within the cavity. In such embodiments, the thermal coupling between the pitcher and the cooling element may be improved.

In embodiments, the cooling element comprises an evaporator element, and the cooling system further comprises a condenser element located remote from the evaporator element, and a compressor fluidly connected between the evaporator element and the condenser element. In such embodiments, the cooling system will work by circulating a refrigerant between the evaporator element and the condenser element, as is known.

In embodiments the cooling system is configured to cool the pitcher to sub-zero temperatures (temperatures lower than 0° C.), for example, in embodiments the cooling system is configured to cool the pitcher to temperatures in the range 0° C. to −6° C. Preferably, the cooling system is configured to cool the pitcher (and hence the contents of the pitcher) to a temperature of approximately −3° C.

In embodiments, the body comprises one or more guide rails configured to cooperate with corresponding guide features on the vehicle galley compartment, wherein the guide rails comprise insulation configured to reduce the transfer of vibrations from the body to the vehicle galley compartment.

According to a further aspect of the disclosure, there is provided a pitcher system for use with a cooling system, and a motor, to make frozen slush drinks, the pitcher system comprising:
a pitcher;
a blending blade configured to be rotationally driven by the motor; and
a stirring element configured to be rotationally driven by the motor,
   wherein the pitcher system is configured such that ingredients are blended by the blending blade, and then stirred by the stirring element whilst the cooling system cools the pitcher, resulting in a frozen slush drink.

It will be appreciated that this aspect may (and preferably does) include one or more (e.g. all) of the preferred and optional features disclosed herein, e.g. relating to other aspects and embodiments of the disclosure, as applicable.

According to a further aspect of the disclosure, there is provided a beverage making system for producing frozen slush drinks comprising:
a cooling system;
a motor, and
a pitcher system, the pitcher system comprising:
   a pitcher;
   a blending element configured to be rotationally driven by the motor; and
   a stirring element configured to be rotationally driven by the motor,
      wherein the beverage making system is configured such that the cooling system cools the pitcher.

It will be appreciated that this aspect may (and preferably does) include one or more (e.g. all) of the preferred and optional features disclosed herein, e.g. relating to other aspects and embodiments of the invention, as applicable.

It will be understood that references made herein to the terms “below”, “above”, “top”, “bottom”, “higher”, “lower”, “base” are intended to refer to the situation where the galley insert chilled beverage device is in its normal orientation (the orientation shown in the Figures).

### BRIEF DESCRIPTION OF THE DRAWINGS

One or more non-limiting examples will now be described, by way of example only, and with reference to the accompanying figures in which:

FIG. 1 shows a perspective view of a vehicle galley, and a galley insert beverage making system in accordance with an embodiment of the invention;

FIG. 2 shows a perspective view of the galley insert beverage making system of FIG. 1;

FIG. 3 shows a cutaway view of a galley insert beverage making system in accordance with an embodiment of the invention;

FIG. 4 shows an exploded view of a pitcher system;

FIG. 5 shows a schematic diagram of first and second meshing elements for use in the galley insert beverage making system; and

FIG. 6 shows a method of using the galley insert beverage making system.

### DETAILED DESCRIPTION

The below described embodiments will be understood to be exemplary only. Further, although the below described embodiments are discussed in relation to an aircraft galley, it will be understood that the gallery insert beverage making system of the present disclosure may be used in any vehicle galley. For example, the galley of a coach, or a train. Further, it is envisaged that the novel concepts disclosed herein may be applied to systems independent of vehicle galleys.

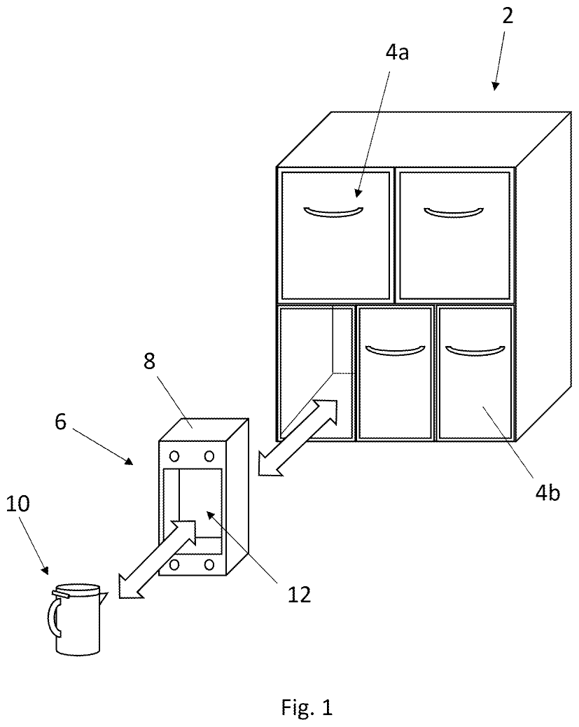

FIG. 1 shows a vehicle galley 2 (such as an aircraft galley), containing a plurality of galley compartments 4a, 4b. FIG. 1 also shows a gallery insert beverage making system 1 configured to be received within a galley compartment 4a, 4b. In the illustrated embodiment, the vehicle galley 2 comprises two sizes of compartment 4a, 4b, large galley compartments 4a and small galley compartments 4b. The large compartments 4a may house larger appliances such as galley ovens (not shown) whilst the small compartments 4b may be used for beverage makers or storage. In the illustrated embodiment, the gallery insert beverage making system 6 is configured to be received within a small galley compartment 4b.

As can be seen from FIG. 1, the gallery insert beverage making system 6 comprises two main parts, a body 8, which is approximately cuboidal, and is shaped and sized to be received within the galley compartment 4b, and a pitcher system 10. The body 8 defines a cavity 12 which is configured to receive the pitcher system 10. The pitcher system 10 may therefore be removed from the cavity 12 when preparing and serving beverages (e.g. to fill and empty the pitcher system 10).

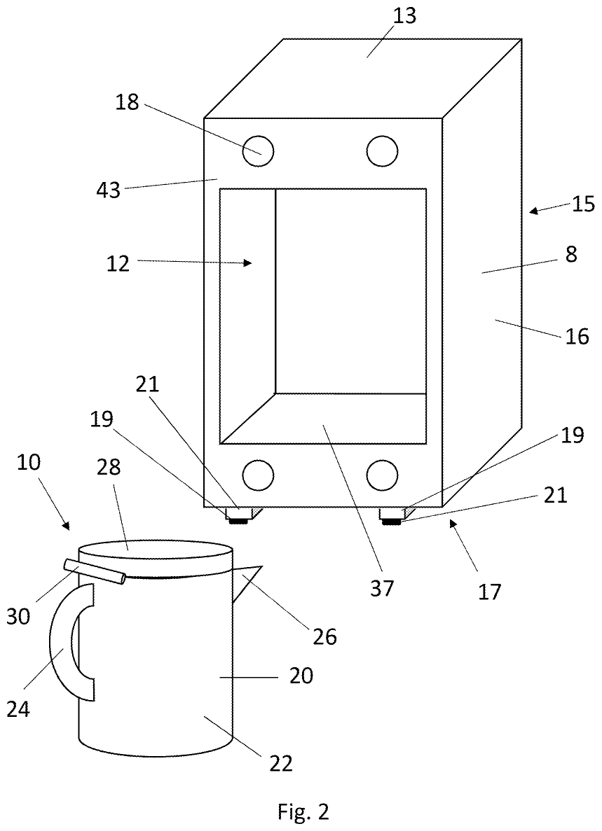

FIG. 2 shows an enlarged view of the galley insert beverage making system 6. The body 8 comprises a front face 14 which defines an opening into the cavity 12, a back face 15 opposite the front face 14, a top face 13, a bottom face 17, and a pair of side faces 16 which extend between the front face 14 and the back face 15, and are perpendicular to the top and bottom faces 13, 17. A plurality of input buttons 18 (four in the illustrated embodiment), configured to accept user inputs, are provided on the front face 14. A plurality of guide rails 19 (two in the illustrated embodiment) are provided on the bottom face 17 of the body 8. These guide rails 19 are configured to align with rails or channels inside the galley compartment 4b (not shown) to aid the secure fitting of the body 8 inside the galley compartment 4b. The guide rails 19 comprise rubber insulating strips 21, the function of which is discussed below.

The pitcher system 10 comprises a pitcher 20 comprising an approximately cylindrical container 22, a handle 24, a pouring spout 26, a lid 28, and a hinge 30 connecting the lid 28 to the container 22 proximal to the handle 24.

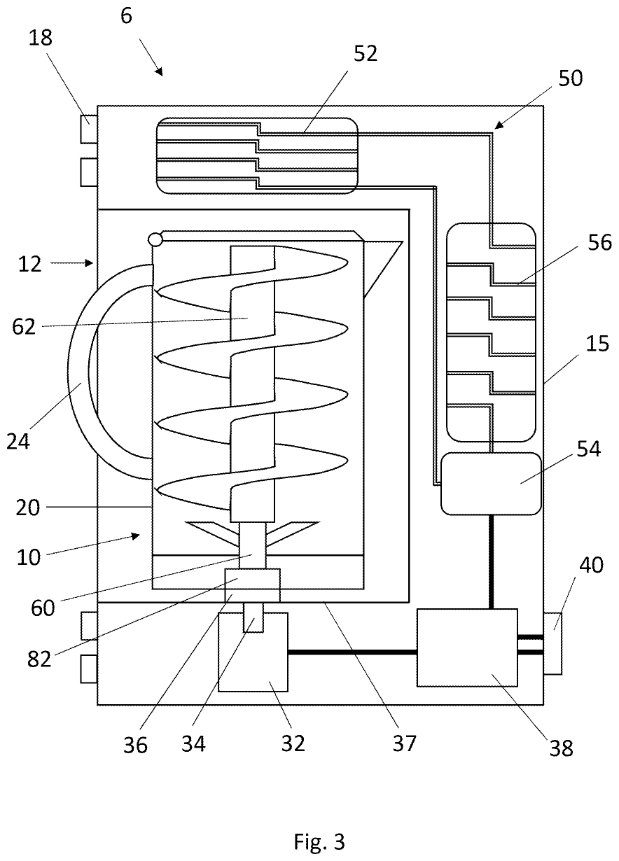

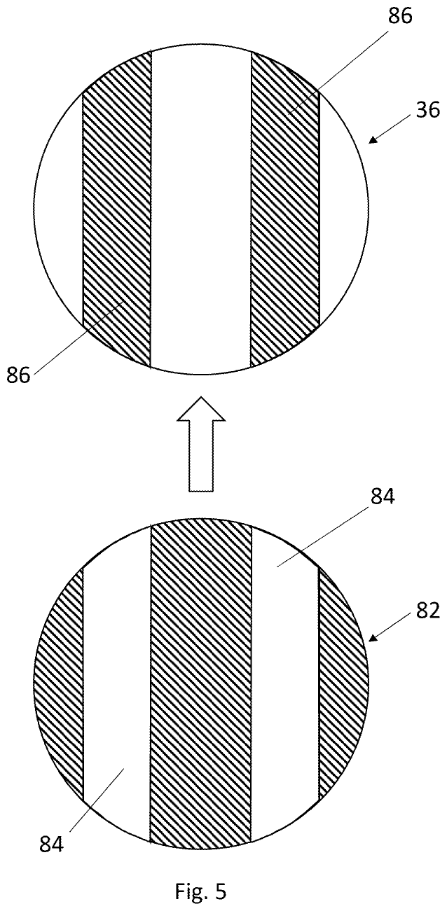

FIG. 3 shows a schematic cut-through diagram of the galley insert beverage making system 6 according to an embodiment of the present disclosure. In addition to the external features described above in relation to FIG. 1 and FIG. 2, it can be seen from FIG. 3 that the body 8 comprises a plurality of internal features. The body 8 comprises a motor 32, a drive shaft 34, and a first meshing element 36. The first meshing element 36 is coupled to the motor 32 by the drive shaft 34 such that rotation of the motor results in rotation of the first meshing element 36. The first meshing element 32 protrudes from the floor 37 of the cavity 12. The first meshing element 32 is described in detail below in relation to FIG. 5. The motor 32 is controlled by an electronics control module 38, and powered by an external power supply (not shown) which is connected to via a connector 40 provided on the back face 15 of the body 8. The connector 40 may be a universal fitting designed to interface with a corresponding universal fitting provided on the interior of galley compartments 4.

Although it will be understood that any suitable electrical motor may be used, in embodiments, the motor 32 is of the type used in aircraft galley fan ovens to drive the fan. Such a motor 32 is an EC motor having an 80 Watt power rating, and a torque of 0.075 Nm at 7600 rpm. This motor is preferable since it is already certified for use in aircraft (for example from the perspective of noise pollution). Noise pollution of the beverage making system is further reduced by the insulating strips 21 which are present on the guide rails 19. The insulating strips 21 help to reduce the amount of vibration which is transferred from the motor 32 to the vehicle galley 2.

The beverage making system 6 further includes a cooling system 50. The cooling system 50 comprises a cooling element 52 which, in the illustrated embodiment, is provided above the cavity 12. In the illustrated embodiment, the cooling element 52 is an evaporator element and the cooling system 50 further comprises a compressor 54, and a condenser element 56. Refrigerant is circulated between the condenser element 56 and the evaporator element 52. The evaporator element 52 converts the refrigerant from liquid to gas. During this process, heat transfer occurs in the evaporator element 52 and the surface of the element 52 is cooled, in turn cooling the pitcher 20 and thus cooling the contents (beverage) inside.

Once the refrigerant has moved through the evaporator element 52, it passes into the compressor 54 which increases pressure on the gas. This causes the gas to condense into a liquid state. As the refrigerant changes into its liquid state, the refrigerant releases the heat which it has absorbed from the pitcher 20. The heat is dispersed by the condenser element 56. The liquid refrigerant then moves back into the evaporator element 52 and the cycle continues.

In the illustrated embodiment, the cooling element 52 is formed as a coil which is located above the pitcher 20 when the pitcher 20 is received in the cavity 12. The illustrated arrangement may be advantageous for cooling since the cooled liquid at the top of the pitcher will naturally fall, creating a convection current inside the pitcher. However, it is envisaged that the cooling element may take any suitable form (e.g. a non-coiled form) and may be placed in any position which is suitably close to the pitcher 20. For example, the cooling element 52 may be provided at the side of the pitcher 20 and/or may partially surround the pitcher 20. The cooling system 50 of the illustrated embodiment is configured to cool the liquid in the pitcher 20 to a temperature in the range 0° C. to −3° C.

The handle 24 is thermally insulated from the container 22 in order to prevent discomfort when handling a pitcher 20 that has been cooled to sub-zero temperatures. Sub zero will be understood to mean temperatures lower than 0° C.

It can be seen in FIG. 3 that the electronics control module 38 is connected to the cooling system 50 and to the motor 32. For clarity of the Figures, the connections between the electronics control module 38 and the components of the body 8 (such as the cooling system 50, motor 32, and input buttons 18) have been simplified or omitted, but it will be understood that the electronics control module 38 is connected to electrical components of the body 8 as necessary. For example, the electronics control module 38 controls the cooling system 50, and the motor 32, at least partially in response to user inputs received at the input buttons 18.

The pitcher system 10 comprises the pitcher 20, as well as a blending element 60, and a stirring element 62. The pitcher 20 comprises a meshing element 82 which is configured to cooperate with the meshing element 36 of the body. The design of the meshing elements 36, 82 is described in more detail below, with reference to FIG. 5.

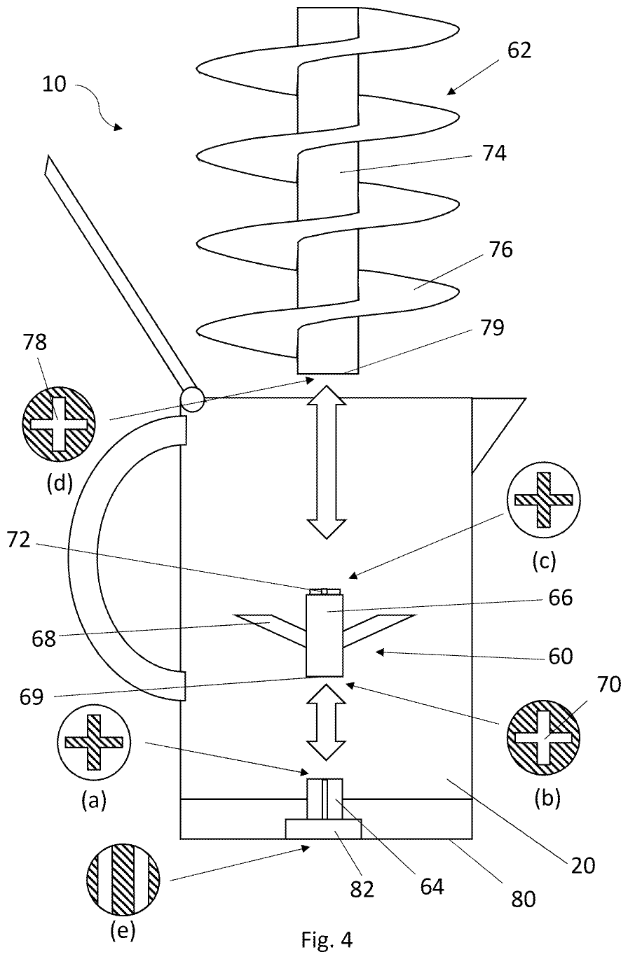

FIG. 4 shows the pitcher system 10 in exploded view. The pitcher 20 comprises a drive shaft 64 which is configured to be rotationally driven by the motor 32 when the pitcher 20 is received in the cavity 12. In the illustrated embodiment, the drive shaft 64 has a cross shaped cross-section, as shown in the inset image (a). In each of the inset images (a)-(d) it will be understood that hatched areas are raised relative to white areas.

The blending element 60 comprises a main shaft 66, and a plurality of blades 68. At the base 69 of the blending element, a cross shaped depression 70 is formed, as shown in the inset image (b). The depression 70 is sized to at least partially receive the drive shaft 64. The main shaft 66 further comprises a cross shaped protrusion 72 provided on the top of the main shaft 66. This can be seen in the inset image (c). It will be understood that, in embodiments, the male/female relationship of the main shaft 66 and drive shaft 64 may be reversed without impacting the function of the components.

The stirring element 62 comprises a main shaft 74, and a spiral blade 76 which wraps around the main shaft 74. In the illustrated embodiment, the stirring element 62 is formed as an Archimedes screw, but it will be understood that other spiral blade configurations may also be used. For example, in embodiments, the blade 76 may not be connected to the main shaft 74 along its entire length, and may instead only be joined to the main shaft 74 at its ends.

In the illustrated embodiment, a cross shaped depression 78 is formed at the base 79 of the main shaft 74, as shown in the inset image (d). The depression 78 is sized to at least partially receive the cross shaped protrusion 72 provided on the top of the main shaft 66 of the blending element 60. In the illustrated embodiment, the depressions 70, 78 on the blending element 60 and the stirring element 62 have identical cross sections, such that both the blending element 60 and the stirring element 62 can be fitted directly to the cross-shaped drive shaft 64 of the pitcher 20.

As a result of the interlocking cross shapes, when the stirring element 62, blending element 60, and drive shaft 64 are mated, rotational movement of the drive shaft results in rotational movement of the blending element 60 and stirring element 62.

Although a cross shape is used in the illustrated embodiment, it will be understood that any suitable interlocking shape which prevents relative rotational movement between mated elements could be used, for example a star shape, or simply straight bars.

At its base 80, the pitcher 20 comprises a second meshing element 82. This second meshing element 82 is formed as a circular disk comprising two parallel depressions 84, as shown in the inset image (e). The second meshing element 82 is configured to engage with the first meshing element 36 which is coupled to the motor 32. The first and second meshing elements 36, 82, are shown in FIG. 5. The first meshing element 36 comprises two parallel bar protrusions 86 which are sized to engage with the two parallel depressions 84 of the meshing element 82. As a result of the interlocking meshing elements 36, 82, when the first and second meshing elements, 36, 82 are mated, rotational movement of the motor 32, drive shaft 34, and first meshing element 36 results in rotational movement of the second meshing element 82. Although parallel bar shapes are used in the illustrated embodiment, it will be understood that any suitable interlocking shape which prevents relative rotational movement between mated elements could be used, for example the cross shapes discussed above. However, the illustrated embodiment is considered to be advantageous since the parallel bar configuration makes it easier for the pitcher 20 to be slid into place in the cavity 12.

It will of course be understood that, in embodiments, the male/female relationship of each of the pairs of interlocking elements may be reversed, and that such an amendment would not impact the function of the interlocking elements.

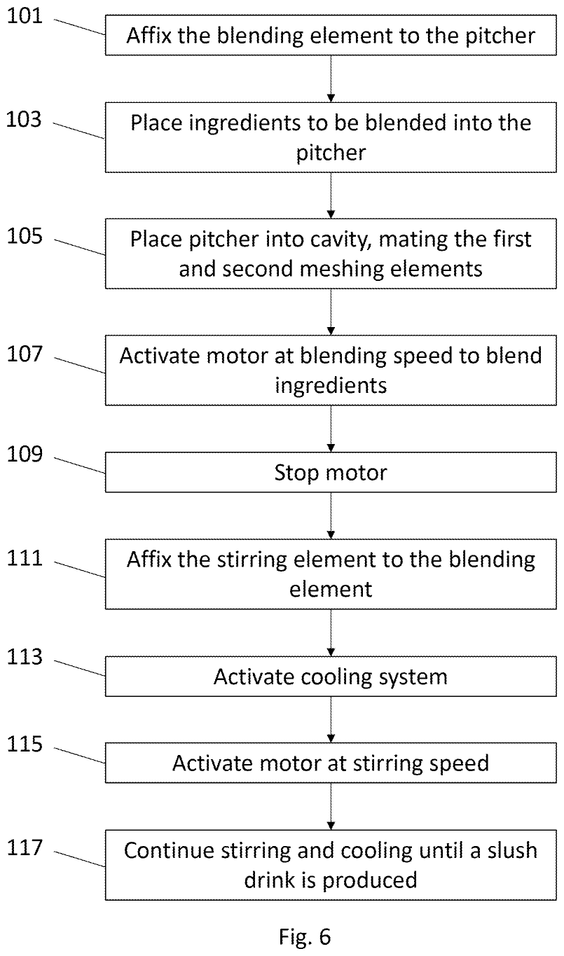

The overall function of the beverage making system 6 will now be described with reference to FIG. 6, which shows an outline of the steps for producing a slush drink with a beverage making system 6 according to the present disclosure. At step 101, the blending element 60 is affixed to the pitcher 20 as described above in relation to FIG. 4. At step 103, the lid 28 of the pitcher 20 is opened and the ingredients (such as fruits) are placed into the pitcher 20. At step 105, the pitcher 20 is placed into the cavity 12 of the body 8. In placing the pitcher 20 into the cavity 12, it must be ensured that the first and second meshing elements 36, 82 are mated.

The motor 32 is configured to operate at two speeds, a blending speed, and a stirring speed. The speed at which the motor 32 operates is controlled by the electronics control module 38. In the illustrated embodiment, the blending speed is 7000 rpm whilst the stirring speed is 100 rpm. In embodiments, the electronics control module 38 may operate a set of instructions such that the speed of the motor 32 is controlled automatically. For example, a user may simply initiate a beverage making sequence. However, in the illustrated embodiment, the operating speed of the motor 32 is manually selected by the user, using the input buttons 18.

At step 107, a user gives an input using a button 18 that the motor 32 should start operating at the blending speed. The electronics control module 38 therefore instructs the motor 32 to operate at the blending speed. Due to the coupling of the motor 32, drive shaft 34, first meshing element 36, second meshing element 82, pitcher drive shaft 64 and blending element 60, the ingredients are blended by the rotating blades 68.

Once the ingredients are blended, at step 109, the motor 32 is stopped. In embodiments, the electronics control module 38 may instruct the motor 32 to stop automatically, for example as a result of a predetermined blending time being reached. In the illustrated embodiment however, the user instructs the motor 32 to stop operating by providing an input using a button 18.

At step 111, once the blending element 60 has stopped rotating, the stirring element 62 is manually fitted to the top of the blending element 60, as described above in relation to FIG. 4. It is envisaged that an automatic mechanism for fitting the stirring element could be devised.

At step 113, the cooling system 50 is activated. It will be understood that in embodiments, in order to speed up the process, the cooling system 50 may be activated earlier, for example at the same time as the ingredients are being blended. In embodiments, the electronics control module 38 may operate a set of instructions such that the cooling system 50 is controlled automatically. For example, a user may simply initiate a beverage making sequence. However, in the illustrated embodiment, the cooling system 50 is manually activated by the user, using the input buttons 18.

At the same time, at step 115, a user gives an input using a button 18 that the motor 32 should start operating at the stirring speed. The electronics control module 38 therefore instructs the motor 32 to operate at the stirring speed. Due to the coupling between the blending element 60 and the stirring element 62, the stirring element 62 is driven to rotate at the stirring speed. As is known, continuously stirring the liquid with a spiral blade 76 whilst it freezes disperses the ice crystals and prevents the liquid from freezing solid, instead producing a slushy liquid. This stirring and cooling is continued, at step 117, until a slush drink is produced.

In the described embodiment, input buttons are provided to accept user inputs. It will be understood that any suitable user input device may be used in place of or in addition to input buttons, such as knobs, dials, touch screens toggle switches etc.

The galley insert beverage making system of the present disclosure may therefore enable the production of chilled drinks (e.g. such as frozen slush drinks) within a vehicle galley (such as an aircraft galley). This offers an improved customer experience over the usual offering of hot water, or cold beverages served from cans or bottles.

It will be seen from the above, that in some embodiments, the design of the pitcher system improves the ease of cleaning.

It will be seen from the above, that in some embodiments, the design of the pitcher system allows blending to be carried out without the stirring element obstructing the blending process.

It will be seen from the above that, in some embodiments, the design of the stirring element may improve the circulation of liquid inside the pitcher and prevent the grouping of ice crystals.

It will be seen from the above that, in some embodiments, it may be possible to leave the blending element inside the pitcher whilst a stirring process is occurring using the stirring element. This prevents the requirement for a user to either reach into the liquid, or empty out the liquid, in order to retrieve the blending element before the stirring element can be fitted.

It will be seen from the above that, in some embodiments, the transmission of noise from the motor into the galley compartment may be reduced.

It will therefore be seen that in accordance with the above disclosed embodiments, slush drinks made from solid ingredients, such as fruit, can be produced using a single system. More particularly, such drinks can be produced on a vehicle such as an aircraft.

1. A galley insert beverage making system for producing chilled drinks comprising:
a body configured to be inserted into a vehicle galley compartment, the body comprising:
a cooling system; and
a motor, and
a pitcher system comprising:
a pitcher;
a blending element configured to be rotationally driven by the motor; and
a stirring element configured to be rotationally driven by the motor,
wherein the body defines a cavity configured to receive the pitcher, and wherein the system is configured such that the cooling system cools the pitcher.

2. The galley insert beverage making system of claim 1, wherein the body comprises a first meshing element which is coupled to the motor, and wherein the pitcher comprises a second meshing element which is coupled to the blending element and/or to the stirring element, wherein the first and second meshing elements are configured to mesh when the pitcher is received inside the cavity such that rotational drive is transferred from the motor to the blending element and/or to the stirring element.

3. The galley insert beverage making system of claim 1, wherein the blending element and/or the stirring element is configured to be removable from the pitcher.

4. The galley insert beverage making system of claim 1, wherein the stirring element comprises a stirring blade having a spiral shape.

5. The galley insert beverage making system of claim 1, wherein the stirring element is configured to removably attach to the blending element.

6. The galley insert beverage making system of claim 5, wherein the blending element comprises a third meshing element and wherein the stirring element comprises a fourth meshing element, wherein the third and the fourth meshing elements are configured to mesh when the stirring element is attached to the top of the blending element such that rotational drive is transferred from the blending element to the stirring element.

7. The galley insert beverage making system of claim 1, wherein the motor is configured to operate at least two rotational speeds, a blending speed, and a stirring speed, wherein the blending speed is greater than the stirring speed.

8. The galley insert beverage making system of claim 7, wherein the blending speed is greater than 5000 RPM, and/or wherein the stirring speed is below 500 RPM.

9. The galley insert beverage making system of claim 1, wherein the cooling system comprises a cooling element located proximal to the cavity such that the cooling element is proximal to the pitcher when the pitcher is received within the cavity.

10. The galley insert beverage making system of claim 9, wherein the cooling element is configured to be in contact with an outer surface of the pitcher when the pitcher is received within the cavity.

11. The galley insert beverage making system of claim 9, wherein the cooling element comprises an evaporator element, and wherein the cooling system further comprises a condenser element located remote from the storage tank, and a compressor fluidly connected between the evaporator element and the condenser element.

12. The galley insert beverage making system of claim 1, wherein the cooling system is configured to cool the beverage to sub-zero temperatures.

13. The gallery insert beverage making system of claim 1, wherein the body comprises one or more guide rails configured to cooperate with corresponding guide features on the vehicle galley compartment, wherein the guide rails comprise insulation configured to reduce the transfer of vibrations from the body to the vehicle galley compartment.

14. A pitcher system for use with a cooling system, and a motor, to make frozen slush drinks, the pitcher system comprising:
a pitcher;
a blending blade configured to be rotationally driven by the motor; and
a stirring element configured to be rotationally driven by the motor,
wherein the pitcher system is configured such that ingredients are blended by the blending blade, and then stirred by the stirring element whilst the cooling system cools the pitcher, resulting in a frozen slush drink.

15. A beverage making system for producing frozen slush drinks comprising:
a cooling system;
a motor, and
a pitcher system, the pitcher system comprising:
a pitcher;
a blending element configured to be rotationally driven by the motor; and
a stirring element configured to be rotationally driven by the motor,
wherein the beverage making system is configured such that the cooling system cools the pitcher.
